(19) United States
(12) Patent Application Publication
(10) Pub. No.: US 2006/0189756 A1
(43) Pub. Date: Aug. 24, 2006

(54) POLYMER BLENDS

(76) Inventors: James M. Nelson, Woodbury, MN (US); John W. Longabach, Woodbury, MN (US); Ryan E. Marx, Rosemount, MN (US); Terri A. Shefelbine, St. Paul, MN (US)

Correspondence Address: 3M INNOVATIVE PROPERTIES COMPANY, PO BOX 33427, ST. PAUL, MN, 55133-3427, US

(21) Appl. No.: 11/276,305

(22) Filed: Feb. 23, 2006

Related U.S. Application Data
(60) Provisional application No. 60/655,388, filed on Feb. 23, 2005.

(51) Int. Cl. C08L 53/00

(52) U.S. Cl. 525/92 R

(57) ABSTRACT

Certain block copolymers may be suitable as compatibilizers in multiple component polymeric blends and composites. The utilization of at least one block copolymer in polymeric blends augments physical properties in the polymeric blend composite. The addition of block copolymers to polymeric blends may enhance certain mechanical properties of the composite, such as tensile strength, impact resistance, modulus, and heat stability, over the initial levels achieved by polymeric blends without incorporating block copolymers.

### CROSS-REFERENCE TO RELATED APPLICATION

This application claims priority to U.S. Provisional Patent No. 60/655388, filed Feb. 23, 2005, herein incorporated by reference in its entirety.

### SUMMARY

The present invention is directed to the use of block copolymers as compatibilizers in multiple component polymeric blends and composites. The utilization of at least one block copolymer in polymeric blends augments physical properties in the polymeric blend composite. The addition of block copolymers to polymeric blends may enhance certain mechanical properties of the composite, such as tensile strength, impact resistance, modulus, and heat stability, over the initial levels achieved by polymeric blends without incorporating block copolymers.

The composition of the present invention comprises a polymeric blend comprised of two immiscible polymers and at least one block copolymer. Other optional materials such as fillers or additives may be utilized as well. The block copolymer has at least one segment that is different than a first immiscible polymer in the blend but capable of interacting with one segment of the first polymer. The block copolymer utilized in the present invention also includes another segment that is different than the second immiscible polymer but capable of interacting with the second polymer. For purposes of the invention, the interaction between the block copolymer and each of the immiscible polymers in the polymeric blend is generally recognized as the formation of a bond through either covalent bonding, hydrogen bonding, dipole bonding, ionic bonding, or combinations thereof. The interaction involving at least one segment of the block copolymer and immiscible polymer is capable of enhancing or restoring mechanical properties of the polymeric blend to desirable levels in comparison to polymeric blends without the block copolymer.

The present invention is also directed to a method of forming a polymeric blend containing at least two immiscible polymers and a block copolymer. The block copolymer is capable of interacting with each of the immiscible polymers to preferably form a compatible polymeric blend. The addition of a block copolymer to blends of immiscible polymers has applicability in either thermoplastic, elastomeric or thermosetting compositions. The polymer combinations useful in the inventive composition include all conventional polymers suitable for use in a polymeric blend.

In a preferred embodiment, a block copolymer may be tailored for each immiscible polymer in the blend, a specific filler, multiple fillers, or combinations thereof, thus adding a broad range of flexibility. In addition, various physical properties can be augmented through block design. Alternatively, the block copolymers may be used in tandem with random copolymers.

### DEFINITIONS

For purposes of the present invention, the following terms used in this application are defined as follows:

“polymer blend” or “polymeric blend” refers to a mixture of two or more polymeric materials where one polymeric material forms the continuous phase or a co-continuous phase of two or more materials;

“block” refers to a portion of a block copolymer, comprising many monomeric units, that has at least one feature which is not present in the adjacent blocks;

“compatible mixture” refers to a material capable of forming a dispersion in a continuous matrix of a second material, or capable of forming a co-continuous polymer dispersion of both materials;

“interaction between the block copolymers and the matrix polymers” refers to the formation of a bond through either covalent bonding, hydrogen bonding, dipole bonding, or ionic bonding or combinations thereof,

“block copolymer” means a polymer having at least two compositionally discrete segments, e.g. a di-block copolymer, a tri-block copolymer, a random block copolymer, a star-branched block copolymer or a hyper-branched block copolymer;

“random block copolymer” means a copolymer having at least two distinct blocks wherein at least one block comprises a random arrangement of at least two types of monomer units;

“di-block copolymers or tri-block copolymers” means a polymer in which all the neighboring monomer units (except at the transition point) are of the same identity, e.g., -AB is a di-block copolymer comprised of an A block and a B block that are compositionally different and ABC is a tri-block copolymer comprised of A, B, and C blocks, each compositionally different;

“star-branched block copolymer” or “hyper-branched block copolymer” means a polymer consisting of several linear block chains linked together at one end of each chain by a single branch or junction point, also known as a radial block copolymer;

“end functionalized” means a polymer chain terminated with a functional group on at least one chain end; and

“immiscible” means two polymers or components that are not mutually soluble in each other at the temperature of interest (processing or use). An immiscible blend is a mixture of two or more components that forms distinct phases consisting primarily of nearly pure components.

### BRIEF DESCRIPTION OF THE DRAWINGS

FIG. 1 depicts a photomicrograph of an annealed and coated slide of a comparative example; and

FIG. 2 depicts a photomicrograph of an annealed and coated slide of an example of the invention.

### DETAILED DESCRIPTION

The polymeric blends includes at least two immiscible polymers and one or more block copolymers in a compatible mixture. Other optional materials such as fillers or additives may be employed as well. The block copolymer has at least one segment that is capable of interacting with one polymer and another segment that is capable of interacting with another polymer in the blend. The interaction involving at least one segment of the block copolymer and one polymer component is capable of enhancing or restoring mechanical properties of the polymeric blend to desirable levels in comparison to polymeric blends without the block copolymer.

### Polymeric Components

The immiscible polymeric components are generally any thermoplastic or thermosetting polymer or copolymer upon which a block copolymer, or a plurality of block copolymers may be employed. The polymeric component includes both hydrocarbon and non-hydrocarbon polymers. Examples of useful polymeric components include, but are not limited to, polyamides, polyimides, fluoropolymers, polyurethanes, polyolefins, polystyrenes, polyesters, polycarbonates, polyketones, polyureas, and polyvinyl resins.

One preferred application involves melt-processible polymers where the constituents are dispersed in a melt mixing stage prior to formation of an extruded or molded polymer article.

For purposes of the invention, melt processible compositions are those that are capable of being processed while at least a portion of the composition is in a molten state.

Conventionally recognized melt processing methods and equipment may be employed in processing the compositions of the present invention. Non-limiting examples of melt processing practices include extrusion, injection molding, batch mixing, and rotomolding.

Another preferred application involves solvent blending prior to coating for coating applications. For this application, the composition of the present invention is dissolved in one or more solvents and then cast as a coating. Non-limiting examples of solvent blended applications include adhesives, lacquers and paints.

Preferred polymeric components include polyolefins (high density polyethylene (HDPE), low density polyethylene (LDPE), linear low density polyethylene (LLDPE), polypropylene (PP)), polyolefin copolymers (e.g., ethylene-butene, ethylene-octene, ethylene vinyl alcohol), polystyrenes, polystyrene-containing polymers and copolymers (e.g., high impact polystyrene, styrene-isoprene-styrene (SIS), styrene-butadiene-styrene (SBS), styrene-ethylene-butylene-styrene (SEBS), acrylonitrile butadiene styrene (ABS)), polyacrylates, polymethacrylates, polyesters, polyvinylchloride (PVC), fluoropolymers, liquid crystal polymers, polyamides, polyether imides, polyphenylene sulfides, polysulfones, polyacetals, polycarbonates, polyphenylene oxides, polyurethanes, thermoplastic elastomers, epoxies, alkyds, melamines, phenolics, ureas, vinyl esters, or combinations thereof.

Each immiscible polymeric component is included in a melt processible composition in an amount typically greater than about 10% by weight and less than 90%, the other components making up the rest of the composition. Those skilled in the art recognize that the amount of each immiscible polymeric component will vary depending upon, for example, the type of polymer, the type of block copolymer, the type of filler, the processing equipment, processing conditions and the desired end product.

Useful compositions may optionally include conventional additives such as antioxidants, light stabilizers, antiblocking agents, and pigments. The polymeric components may be incorporated into the melt processible composition in the form of powders, pellets, granules, or in any other extrudable form.

Elastomers are another subset of polymers suitable for use in a polymeric blend. Useful elastomeric polymeric resins (i.e., elastomers) include thermoplastic and thermoset elastomeric polymeric resins, for example, polybutadiene, polyisobutylene, ethylene-propylene copolymers, ethylene-propylene-diene terpolymers, sulfonated ethylene-propylene-diene terpolymers, polychloroprene, poly(2,3-dimethylbutadiene), poly(butadiene-co-pentadiene), chlorosulfonated polyethylenes, polysulfide elastomers, silicone elastomers, poly(butadiene-co-nitrile), hydrogenated nitrile-butadiene copolymers, acrylic elastomers, ethylene-acrylate copolymers.

Useful thermoplastic elastomeric polymer resins include block copolymers, made up of glassy or crystalline blocks. For purposes of the invention, polymers suitable for use as polymeric blends are those that are immiscible with a second polymer in a blend yet capable of interaction with at least one segment of a specific block copolymer additive as utilized in the present invention. Non-limiting examples include polystyrene, poly(vinyltoluene), poly(t-butylstyrene), and polyester, and the elastomeric blocks such as polybutadiene, polyisoprene, ethylene-propylene copolymers, ethylene-butylene copolymers. For example, poly(styrene-butadiene styrene) block copolymers marketed by Shell Chemical Company, Houston, Tex., under the trade designation “KRATON”. Additionally, polyether ester block copolymers and the like as may be used. Copolymers and/or mixtures of these aforementioned elastomeric polymeric resins can also be used.

Useful polymeric components may also be fluoropolymers. Useful fluoropolymers include, for example, those that are preparable (e.g., by free-radical polymerization) from monomers comprising 2,5-chlorotrifluoroethylene, 2-chloropentafluoropropene, 3-chloropentafluoropropene, vinylidene fluoride, trifluoroethylene, tetrafluoroethylene, 1-hydropentafluoropropene, 2-hydropentafluoropropene, 1,1-dichlorofluoroethylene, dichlorodifluoroethylene, hexafluoropropylene, vinyl fluoride, a perfluorinated vinyl ether (e.g., a perfluoro(alkoxy vinyl ether) such as CF₃OCF₂CF₂CF₂OCF═CF₂, or a perfluoro(alkyl vinyl ether) such as perfluoro(methyl vinyl ether) or perfluoro(propyl vinyl ether)), cure site monomers such as for example, nitrile containing monomers (e.g., CF₂═CFO(CF₂)LCN, CF₂═CFO[CF₂CF(CF₃)O]_{q}(CF₂O)_{y}CF(CF₃)CN, CF₂═CF[OCF₂CF(CF₃)]ᵣO(CF₂)ₜCN, or CF₂═CFO(CF₂)ᵤOCF(CF₃)CN where L=2-12; q=0-4; r=1-2; y=0-6; t=1-4; and u=2-6), bromine containing monomers (e.g., Z-Rf-Ox-CF═CF₂, wherein Z is Br or I, Rf is a substituted or unsubstituted C₁-C₁₂ fluoroalkylene, which may be perfluorinated and may contain one or more ether oxygen atoms, and x is 0 or 1); or a combination thereof, optionally in combination with additional non-fluorinated monomers such as, for example, ethylene or propylene. Specific examples of such fluoropolymers include polyvinylidene fluoride; copolymers of tetrafluoroethylene, hexafluoropropylene and vinylidene fluoride; copolymers of tetrafluoroethylene, hexafluoropropylene, perfluoropropyl vinyl ether, and vinylidene fluoride; tetrafluoroethylene-hexafluoropropylene copolymers; tetrafluoroethylene-perfluoro (alkyl vinyl ether) copolymers (e.g., tetrafluoroethyleneperfluoro( propyl vinyl ether)); and combinations thereof.

Useful commercially available thermoplastic fluoropolymers include, for example, those marketed by Dyneon, LLC, Oakdale, Minn., under the trade designations “THV” (e.g., “THV 220”, “THV 400G”, “THV 500G”, “THV 815”, and “THV 610X”), “PVDF”, “PFA”,“HTE”, “ETFE”, and “FEP”; those marketed by Atofina Chemicals, Philadelphia, Pa., under the trade designation “KYNAR” (e.g., “KYNAR 740”); those marketed by Solvay Solexis, Thorofare, N.J., under the trade designations “HYLAR” (e.g., “HYLAR 700”) and “HALAR ECTFE”.

### Block Copolymers

The one or more block copolymers are preferably designed to interact with each of the immiscible polymers in the polymeric matrix to form a compatible blend. A compatible mixture refers to a material capable of forming a dispersion in a continuous matrix of a second material, or capable of forming a co-continuous polymer dispersion of both materials. The block copolymer has at least one segment that is different than a first polymer of the polymeric blend yet is capable of interacting with the first polymer. The block copolymer also has at least one segment different than a second polymer that is capable of interacting with the second polymer. In one sense, and without intending to limit the scope of the present invention, applicants believe that the block copolymer may act as a compatibilizing agent to the immiscible polymers in the polymeric blend.

Preferred examples of block copolymers include di-block copolymers, tri-block copolymers, random block copolymers, star-branched copolymers or hyper-branched copolymers. Additionally, block copolymers may have end functional groups.

Block copolymers are generally formed by sequentially polymerizing different monomers. Useful methods for forming block copolymers include, for example, anionic, cationic, coordination, and free radical polymerization methods.

The block copolymers interact with the polymers in the immiscible blend through functional moieties. Functional blocks typically have one or more polar moieties such as, for example, acids (e.g., —CO₂H, —SO₃H, —PO₃H); —OH; —SH; primary, secondary, or tertiary amines; ammonium N-substituted or unsubstituted amides and lactams; N-substituted or unsubstituted thioamides and thiolactams; anhydrides; linear or cyclic ethers and polyethers; isocyanates; cyanates; nitriles; carbamates; ureas; thioureas; heterocyclic amines (e.g., pyridine or imidazole)). Useful monomers that may be used to introduce such groups include, for example, acids (e.g., acrylic acid, methacrylic acid, itaconic acid, maleic acid, fumaric acid, and including methacrylic acid functionality formed via the acid catalyzed deprotection of t-butyl methacrylate monomeric units as described in U.S. Pat. Publ. No. 2004/0024130 (Nelson et al.)); acrylates and methacrylates (e.g., 2-hydroxyethyl acrylate), acrylamide and methacrylamide, N-substituted and N,N-disubstituted acrylamides (e.g., N-t-butylacrylamide, N,N-(dimethylamino)ethylacrylamide, N,N-dimethylacrylamide, N,N-dimethylethylenediamine), N-ethylacrylamide, N-hydroxyethylacrylamide, N-octylacrylamide, N-t-butylacrylamide, N,N-dimethylacrylamide, N,N-diethylacrylamide, and N-ethyl-N-dihydroxyethylacrylamide), aliphatic amines (e.g., 3-dimethylaminopropyl amine, N,N-dimethylethylenediamine); and heterocyclic monomers (e.g., 2-vinylpyridine, 4-vinylpyridine, 2-(2-aminoethyl)pyridine, 1-(2-aminoethyl)pyrrolidine, 3-aminoquinuclidine, N-vinylpyrrolidone, and N-vinylcaprolactam).

Other suitable blocks typically have one or more hydrophobic moieties such as, for example, aliphatic and aromatic hydrocarbon moieties such as those having at least about 4, 8, 12, or even 18 carbon atoms; fluorinated aliphatic and/or fluorinated aromatic hydrocarbon moieties, such as for example, those having at least about 4, 8, 12, or even 18 carbon atoms; and silicone moieties.

Non-limiting example of useful monomers for introducing such blocks include: hydrocarbon olefins such as ethylene, propylene, isoprene, styrene, and butadiene; cyclic siloxanes such as decamethylcyclopentasiloxane and decamethyltetrasiloxane; fluorinated olefins such as tetrafluoroethylene, hexafluoropropylene, trifluoroethylene, difluoroethylene, and chlorofluoroethylene; nonfluorinated alkyl acrylates and methacrylates such as butyl acrylate, isooctyl methacrylate lauryl acrylate, stearyl acrylate; fluorinated acrylates such as perfluoroalkylsulfonamidoalkyl acrylates and methacrylates having the formula H₂C═C(R₂)C(O)O—X—N(R)SO₂R_{f′} wherein: R_{f′} is —C₆F₁₃, —C₄F₉, or —C₃F₇; R is hydrogen, C₁ to C₁₀ alkyl, or C₆-C₁₀ aryl; and X is a divalent connecting group. Preferred examples include C₄F₉SO₂N(CH₃)C₂H₄OC(O)NH(C₆H₄)CH₂C₆H₄NHC(O)OC₂H₄OC(O)CH═CH₂

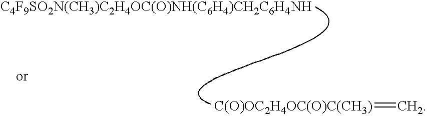

Such monomers may be readily obtained from commercial sources or prepared, for example, according to the procedures in U.S. Pat. No. 6,903,173, U.S. patent application Ser. No. 10/950932, U.S. patent application Ser. No. 10/950834, and U.S. patent application Ser. No. 11/280924, all of which are herein incorporated by reference in their entirety.

Other non-limiting examples of useful block copolymers having functional moieties include poly(isoprene-block-4-vinylpyridine); poly(isoprene-block-methacrylic acid); poly(isoprene-block-glycidyl methacrylate); poly(isoprene-block-methacrylic anhydride); poly(isoprene-block-(methacrylic anhydride-co-methacrylic acid)); poly(styrene-block-4-vinylpyridine); poly(styrene-block-methacrylamide); poly(styrene-block-glycidyl methacrylate); poly(styrene-block-2-hydroxyethyl methacrylate); poly(styrene-block-isoprene-block-4-vinylpyridine); poly(styrene-block-isoprene-block-glycidyl methacrylate); poly(styrene-block-isoprene-block-methacrylic acid); poly(styrene-block-isoprene-block-(methacrylic anhydride-co-methacrylic acid)); poly(styrene-block-isoprene-block-methacrylic anhydride); poly(MeFBSEMA-block-methacrylic acid) (wherein “MeFBSEMA” refers to 2-(N-methylperfluorobutanesulfonamido)ethyl methacrylate, e.g., as available from 3M Company, Saint Paul, Minn.), poly(MeFBSEMA-block-t-butyl methacrylate), poly(styrene-block-t-butyl methacrylate-block-MeFBSEMA), poly(styrene-block-methacrylic anhydride-block-MeFBSEMA), poly(styrene-block-methacrylic acid-block-MeFBSEMA), poly(styrene-block-(methacrylic anhydride-co-methacrylic acid)-block-MeFBSEMA)), poly(styrene-block-(methacrylic anhydride-co-methacrylic acid-co-MeFBSEMA)), poly(styrene-block-(t-butyl methacrylate-co-MeFBSEMA)), poly(styrene-block-isoprene-block-t-butyl methacrylate-block-MeFBSEMA), poly(styrene-isoprene-block-methacrylic anhydride-block-MeFBSEMA), poly(styrene-isoprene-block-methacrylic acid-block-MeFBSEMA), poly(styrene-block-isoprene-block-(methacrylic anhydride-co-methacrylic acid)-block-MeFBSEMA), poly(styrene-block-isoprene-block-(methacrylic anhydride-co-methacrylic acid-co-MeFBSEMA)), poly(styrene-block-isoprene-block-(t-butyl methacrylate-co-MeFBSEMA)), poly(MeFBSEMA-block-methacrylic anhydride), poly(MeFBSEMA-block-(methacrylic acid-co-methacrylic anhydride)), poly(styrene-block-(t-butyl methacrylate-co-MeFBSEMA)), and hydrogenated forms of poly(butadiene-block-4-vinylpyridine), poly(butadiene-block-methacrylic acid), poly(butadiene-block-N,N-(dimethylamino) ethyl acrylate), poly(butadiene-block-2-diethylaminostyrene), poly(butadiene-block-glycidyl methacrylate), Optionally, the block copolymer may be chosen such that at least one segment of a block is capable of interacting with the fillers.

The block copolymers may be end-functionalized polymeric materials that can be synthesized by using functional initiators or by end-capping living polymer chains, as conventionally recognized in the art. The end-functionalized polymeric materials of the present invention may comprise a polymer terminated with a functional group on at least one chain end. The polymeric species may be a homopolymers, copolymers, or block copolymers. For those polymers that have multiple chain ends, the functional groups may be the same or different. Non-limiting examples of functional groups include amine, anhydride, alcohol, carboxylic acid, thiol, maleate, silane, and halide. End-functionalization strategies using living polymerization methods known in the art can be utilized to provide these materials.

Any amount of block copolymer may be used, however, typically the block copolymer is included in an amount in a range of up to 10% by weight.

In a most preferred embodiment, the block copolymer is a polystryrene-4-vinyl pyridine block copolymer, a polyisoprene-4-vinyl pyridine block copolymer, a polystyrene-methacrylic acid block copolymer, a polystyrene-methacrylic acid block copolymer, a polystyrene-methacrylic anhydride block copolymer, a polyisoprene-methacrylic anhydride block copolymer, a polystyrene-fluoromethacrylate block copolymer, or a polyisoprene-fluoromethacrylate block copolymer.

### Fillers

One or more types of conventional fillers may be optionally employed with the polymeric blend of the present invention. The fillers may be any filler generally recognized by those of skill in the art as being suitable for use in a polymeric blend or for use in one of the polymers comprising the blend. The utilization of fillers provides certain mechanical advantages, such as, for example, increasing modulus, increasing tensile strength, and/or improving the strength-to-density ratios. For purposes of the invention, fillers, as used herein, may mean one or more specific types of filler or a plurality of the same individual filler in a polymeric blend.

The fillers useful in the inventive composition include all conventional fillers suitable for use in a polymeric blend or for use in one of the immiscible polymers comprising the blend. Preferred fillers are glass fiber, talc, silica, calcium carbonate, carbon black, alumina silicates, mica, calcium silicates, calcium alumino ferrite (Portland cement), cellulosic materials, nanoparticles, aluminum trihydrate, magnesium hydroxide or ceramic materials. Other fibers of interest include agricultural fibers (plant or animal fiberous materials or byproducts). Cellulosic materials may include natural or wood materials having various aspect ratios, chemical compositions, densities, and physical characteristics. Non-limiting examples of cellulosic materials are wood flour, wood fibers, sawdust, wood shavings, newsprint, paper, flax, hemp, rice hulls, kenaf, jute, sisal, and peanut shells.

Combinations of cellulosic materials, or cellulosic materials with other fillers, may also be used in the composition of the present invention. One embodiment may include glass fiber, talc, silica, calcium carbonate, cellulosic materials, and nanoparticles.

Fillers such as CaCO₃ are often used to reduce the cost and improve the mechanical properties of polymers. Frequently the amount of CaCO₃ that can be added is limited by the relatively poor interfacial adhesion between filler and polymer. This weak interface is the initiation site for cracks that ultimately reduce the strength of the composite.

In another preferred embodiment, the filler is a flame retardant composition. All conventional flame retardant compounds may be employed in the present invention. Flame retardant compounds are those that can be added to a polymeric matrix to render the entire composite less likely to ignite and, if they are ignited, to burn much less efficiently. Non-limiting examples of flame retardant compounds include: chlorinated paraffins; chlorinated alkyl phosphates; aliphatic brominated compounds; aromatic brominated compounds (such as brominated diphenyloxides and brominated diphenylethers); brominated epoxy polymers and oligomers; red phosphorus; halogenated phosphorus; phosphazenes; aryl/alkyl phosphates and phosphonates; phosphorus-containing organics (phosphate esters, P-containing amines, P-containing polyols); hydrated metal compounds (aluminum trihydrate, magnesium hydroxide, calcium aluminate); nitrogen-containing inorganics (ammonium phosphates and polyphosphates, ammonium carbonate); molybdenum compounds; silicone polymers and powder; triazine compounds; melamine compounds (melamine, melamine cyanurates, melamine phosphates); guanidine compounds; metal oxides (antimony trioxide); zinc sulfide; zinc stannate; zinc borates; metal nitrates; organic metal complexes; low melting glasses, nanocomposites (nanoclays and carbon nanoparticles); and expandable graphite. One or more of the compounds may be present in the inventive composition in amounts of about 5% by weight to about 70% by weight.

### Coupling Agents

In a preferred embodiment, the fillers may be treated with a coupling agent to enhance the interaction between the fillers and the block copolymer in the polymeric blend. It is preferable to select a coupling agent that matches or provides suitable reactivity with corresponding functional groups of the block copolymer. Non-limiting examples of coupling agents include zirconates, silanes, or titanates. Typical titanate and zirconate coupling agents are known to those skilled in the art and a detailed overview of the uses and selection criteria for these materials can be found in Monte, S.J., Kenrich Petrochemicals, Inc., “Ken-React® Reference Manual—Titanate, Zirconate and Aluminate Coupling Agents”, Third Revised Edition, March, 1995. The coupling agents are included in an amount of about 1% by weight to about 3% by weight.

Suitable silanes are coupled to glass surfaces through condensation reactions to form siloxane linkages with the siliceous filler. This treatment renders the filler more wettable or promotes the adhesion of materials to the glass surface. This provides a mechanism to bring about covalent, ionic or dipole bonding between inorganic fillers and organic matrices. Silane coupling agents are chosen based on the particular functionality desired. For example, an aminosilane glass treatment may be desirable for compounding with a block copolymer containing an anhydride, epoxy or isocynate group. Alternatively, silane treatments with acidic functionality may require block copolymer selections to possess blocks capable of acid-base interactions, ionic or hydrogen bonding scenarios. Suitable silane coupling strategies are outlined in Silane Coupling Agents: Connecting Across Boundries by Barry Arkles pg 165-189 Gelest Catalog 3000—A Silanes and Silicones: Gelest Inc. Morrisville, Pa. Those skilled in the art are capable of selecting the appropriate type of coupling agent to match the block copolymer interaction site.

The combination of block copolymers with two or more immiscible polymers in a polymeric blend may enhance certain mechanical properties of the resulting composite, such as tensile strength, impact resistance, and modulus. In a preferred embodiment, modulus may be improved by 50% or greater over a comparable polymeric composition without a block copolymer of the present invention. Additionally, tensile strength, impact resistance and percent elongation exhibit improvement of at least 10% or greater when compared to a polymeric composition without a block copolymer of the present invention. In a most preferred example, percent elongation may be improved as much as 200%. The noted improvements are applicable to both thermoplastic and elastomeric polymeric compositions. The enhanced properties may be attributed to the improved dispersion of the immiscible polymers in the matrix as demonstrated through smaller and more uniform domain sizes in the blend. The smaller and more uniform domain sizes result in greater stability of the blend over time due to the reduced propensity of the blend to coalesce.

The improved physical characteristics render the composites of the present invention suitable for use in many varied applications. Non-limiting examples include, automotive parts (e.g. o-rings, gaskets, hoses, brake pads, instrument panels, side impact panels, bumpers, and fascia), molded household parts, composite sheets, thermoformed parts, and structural components, extruded films or sheets, blown films, nonwovens, foams, molded end products, and paints.

### EXAMPLES

A description of the materials utilized throughout the Examples is included in Table 1 below.

TABLE 1
Materials

| Material | Description |
|---|---|
| P(S-MAn) | An AB di-block copolymer, poly[styrene-b-methacrylic acid- |
| | co-methacrylic anhydride]. Synthesized using a stirred tubular |
| | reactor process as described in U.S. Pat. No. 6,448,353 |
| | and U.S. Published Patent Application No. 2004/0024130. |
| | Mn = 125 kg/mol, PDI = 1.5, 95/5 PS/MAn by weight |
| HNBR | hydrogenated nitrile butadiene rubber available under the trade |
| | name Zetpol 1020 from Zeon Chemicals USA, Lexington, |
| | Kentucky |
| FKM | fluoroelastomer copolymer of hexafluoropropylene and vinyl- |
| | idene fluoride available under the trade name FC2145 |
| | available from Dyneon LLC Oakdale, Minnesota |

### EXAMPLES

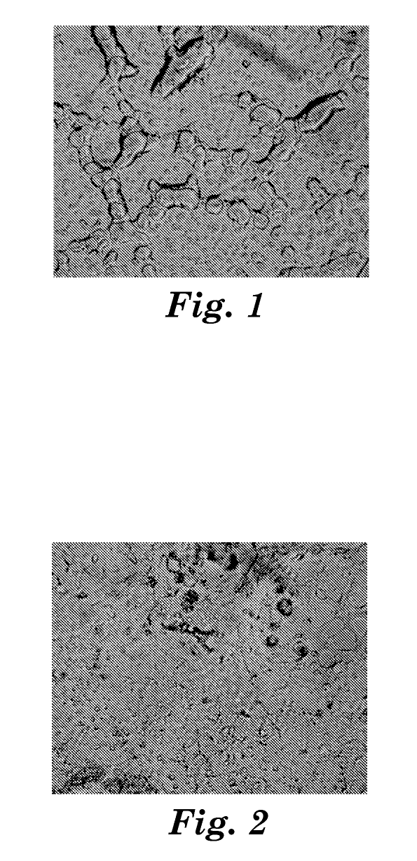

Dissolved in 100 mL tetrahydrofuran (THF) 5 g of Zetpol 11020 hydrogenated nitrile butadiene elastomer HNBR and 5 g of FC2145 fluoroelastomer. The mixture was stirred on a shaker overnight. Removed 1 mL of solution and coat on a microscope slide. Dissolved in 50 mL tetrahydrofuran (THF) 5 g of Zetpol1020 hydrogenated nitrile butadiene elastomer HNBR and 5 g of FC2145 fluoroelastomer and 0.3 g of P(S-Man) CAM. This mixture was stirred on a shaker overnight. Removed 1 mL and coated on a microscope slide. Annealed the coated slides in a vacuum oven at 100 C overnight. Observed the differences in domain size for the blend with block copolymer (FIG. 2) from the blend without a block copolymer (FIG. 1) using a light microscope at 480× magnification. The blend containing the block copolymer exhibited a finer and more uniform domain size.

What is claimed is:

1. A polymeric blend comprising:
a) a first polymer;
b) a second polymer; and
c) a block copolymer wherein the first polymer and the second polymer are immiscible and wherein the block copolymer includes at least one segment different than the first polymer but capable of interacting with the first polymer, and at least one segment different than the second polymer but capable of interacting with the second polymer.

2. A polymeric blend according to claim 1, wherein a compatible blend is formed.

3. A polymeric blend according to claim 1, wherein the block copolymers are included in an amount of up to 10% by weight.

4. A polymeric blend according to claim 1, wherein the first polymer and the second polymer are both capable of being cured to form thermoset polymers.

5. A polymeric blend according to claim 1, wherein the first polymer and the second polymer are thermoplastic.

6. A polymeric blend according to claim 1, wherein the first polymer and the second polymer are non-olefins.

7. A polymeric blend according to claim 1, wherein the block copolymer is selected from one or more of di-block copolymers, a tri-block copolymers, a random block copolymers, star-branched block copolymers, end-functionalized copolymers, or a hyper-branched block copolymers.

8. A polymeric blend according to claim 1, wherein the first polymer is selected from one or more of polyamides, polyimides, polyethers, polyurethanes, polyolefins, polystyrenes, polyesters, polycarbonates, polyketones, polyureas, polyvinyl resins, polyacrylates, fluorinated polymers, and polymethylacrylates.

9. A polymeric blend according to claim 1, further comprising one or more of antioxidants, light stabilizers, fillers, antiblocking agents, plasticizers, microspheres, and pigments.

10. A polymeric blend according to claim 9, further comprising a coupling agent.

11. A polymeric blend according to claim 1, wherein said block copolymer is a polystryrene-4-vinyl pyridine block copolymer, a polyisoprene-4-vinyl pyridine block copolymer, a polystyrene-methacrylic acid block copolymer, a polystyrene-methacrylic acid block copolymer, a polystyrene-methacrylic anhydride block copolymer, a polyisoprene-methacrylic anhydride block copolymer, a polystyrene-fluoromethacrylate block copolymer, or a polyisoprene-fluoromethacrylate block copolymer.

12. A polymeric blend according to claim 1, further comprising two or more block copolymers.

13. A polymeric blend according to claim 1, wherein the block copolymer includes at least one segment that is the same as either the first polymer, the second polymer, or both.

14. A polymeric blend according to claim 1, wherein polymeric blend exhibits one or more of improved tensile strength, impact resistance, modulus, or domain size when compared to a comparable mixture not having the block copolymer.

15. A polymeric blend according to claim 1, wherein the polymeric blend is extruded into a film.

16. A method comprising melt-processing the polymeric blend of claim 1.
